(19) United States
(12) Patent Application Publication
(10) Pub. No.: US 2024/0394563 A1
(43) Pub. Date: Nov. 28, 2024

(54) SYSTEMS AND METHODS FOR CONSTRUCTING TOPIC-SPECIFIC KNOWLEDGE GRAPHS

(71) Applicant: PricewaterhouseCoopers LLP, New York, NY (US)

(72) Inventors: Paul SHEWARD, Chicago, IL (US); Chung-Sheng LI, Scarsdale, NY (US); Scott LIKENS, Austin, TX (US); Saverio FATO, Wilton Manors, FL (US); Joseph Doyle HARRINGTON, Granite Bay, CA (US); Joseph David VOYLES, Louisville, KY (US); Jonathan B. RHINE, Suffern, NY (US); Alex Nicholas BOLDIZSAR, Woodstock, CT (US); Winnie CHENG, West New York, NJ (US); Todd Christopher MORRILL, Newburgh, NY (US); Yuan WAN, Irvine, CA (US); William Spotswood SEWARD, Los Angeles, CA (US)

(73) Assignee: PricewaterhouseCoopers LLP, New York, NY (US)

(21) Appl. No.: 18/321,538

(22) Filed: May 22, 2023

(51) Int. Cl. G06N 5/022; G06F 3/0482; G06F 3/0484; G06F 40/279; G06F 40/30

(52) U.S. Cl. CPC G06N 5/022; G06F 3/0482; G06F 3/0484; G06F 40/279; G06F 40/30

(57) ABSTRACT

Provided is a method for generating a knowledge graph for a topic. First, a set of documents may be received. A user may then provide an indication of exemplary entities associated with a topic of interest. Then, using one or more artificial intelligence models, a plurality of textual entities may be extracted from the documents. A quality level of each extracted textual entity may be determined. Each quality level may indicate a degree of similarity between a textual entity and each exemplary entity of the one or more exemplary entities. Next, a plurality of high-quality textual entities may be identified and categorized according to one or more sub-topics associated with the topic. Connection information indicating relationships between the sub-topics may be determined. Finally, a knowledge graph for the topic that represents the sub-topics in the documents and the relationships between said sub-topics may be generated.

### FIELD

The present disclosure relates generally to systems and methods for generating representations of textual data. In particular, the present disclosure relates to systems and methods for constructing knowledge graphs.

### BACKGROUND

Data, particularly in high volumes, can be difficult to parse and process in its raw form. To increase information processing efficiency, data structures including graphs, diagrams, and charts are frequently employed to organize information in a data set.

Knowledge graphs can be used to represent information contained in textual data. A knowledge graph for a set of documents, for example, may provide a visual representation of important concepts that are present in the documents, as well as visual indications of the meanings of and relationships between said concepts. Users provided with the knowledge graph may be able to identify subject matter discussed in the documents, which may allow them to rapidly determine which documents require a closer read.

### SUMMARY

Knowledge graphs, as discussed, can provide representations of important information contained in a set of documents. However, inefficiencies in existing knowledge graph generation techniques may significantly hinder the usability of the resulting knowledge graphs. Knowledge graphs generated using existing methods may represent all of the important information contained in a set of documents and can be quite extensive. As a result, identifying information that is relevant to a specific topic may be challenging. Furthermore, knowledge graphs may be difficult to update once generated. Whenever documents are added or removed from an underlying document set, a new knowledge graph may need to be created. Creating a new graph from scratch may be time-consuming, particularly if the underlying set of documents is growing in size.

Accordingly, provided are systems and methods for generating topic-specific knowledge graphs that arrange and provide structure to information contained in a set of documents that is related to a certain topic. The described systems and methods may generate topic-specific knowledge graphs by using a combination of artificial intelligence models and user-provided guidance. In particular, the systems and methods may use a filtering procedure to remove irrelevant textual entities so that only those entities that are associated with the user's topic of interest are represented in the knowledge graph. The resulting knowledge graph may help the user to identify documents in the document set that are most relevant to their topic of interest.

In addition to providing topic-specific knowledge graphs, the described techniques may also be used to efficiently update existing knowledge graphs. When new documents are added to an existing set of documents, a knowledge graph may be generated for the new documents. The newly generated knowledge graph may then be compared to and merged with an existing knowledge graph by leveraging the same techniques employed to generate topic-specific knowledge graphs. This may allow knowledge graphs to be updated regularly as new information becomes available.

A method for generating a knowledge graph for a topic may comprise receiving one or more documents from one or more information sources; receiving an indication of one or more exemplary entities associated with the topic from a user; automatically, using one or more artificial intelligence models: extracting a plurality of textual entities from the one or more documents, determining a quality level of each of the plurality of extracted textual entities based on the one or more exemplary entities received from the user, wherein a quality level of a textual entity indicates a degree of similarity between the textual entity and each exemplary entity of the one or more exemplary entities, identifying a plurality of high-quality textual entities from the plurality of textual entities based on the respective quality levels of the plurality of extracted textual entities, categorizing each the plurality of high-quality entities according to one or more sub-topics associated with the topic, and determining connection information indicating relationships between the one or more sub-topics based on documents of the one or more documents from which each of the plurality of high-quality entities originated; and generating, based on the one or more sub-topics and the connection information, a first knowledge graph for the topic that represents the one or more sub-topics in the one or more documents and the relationships between said sub-topics.

In some embodiments, the method comprises providing an indication of the plurality of high-quality textual entities to the user, receiving feedback from the user indicating an accuracy of one or more of the plurality of high-quality textual entities, and automatically updating the plurality of high-quality textual entities based on the feedback received from the user.

In some embodiments of the method, determining the quality level of a textual entity of the plurality of textual entities comprises generating a first vector representing the textual entity, generating a second vector representing an exemplary entity of the one or more exemplary entities, and computing a similarity score between the first vector and the second vector, wherein the similarity score indicates a degree of similarity between the textual entity and the exemplary entity.

In some embodiments of the method, identifying the plurality of high-quality textual entities comprises identifying textual entities of the plurality of textual entities with quality levels that exceed a threshold quality level.

In some embodiments of the method, determining the connection information comprises generating a matrix that indicates which documents of the one or more documents contain which high-quality entities of the plurality of high-quality entities.

In some embodiments, the method comprises receiving a second set of one or more documents from the one or more information sources; automatically, using the one or more artificial intelligence models: extracting a second plurality of textual entities from the second set of one or more documents, determining a quality level of each textual entity of the second plurality of textual entities based on the one or more exemplary entities received from the user, wherein a quality level of a textual entity indicates a degree of similarity between the textual entity and each exemplary entity of the one or more exemplary entities, identifying a second plurality of high-quality textual entities from the second plurality of textual entities based on the quality levels of each textual entity of the second plurality of textual entities, categorizing the second plurality of high-quality entities according to a second set of one or more sub-topics associated with the topic, and determining second connection information indicating relationships between the second set of one or more sub-topics; and generating, based on the second set of one or more sub-topics and the second connection information, a second knowledge graph for the topic that provides a visual representation of the second set of one or more sub-topics in the second set of one or more documents and the relationships between said sub-topics.

In some embodiments, the method comprises combining the first knowledge graph with the second knowledge graph.

In some embodiments of the method, combining the first knowledge graph with the second knowledge graph comprises comparing a first sub-topic represented in the first knowledge graph with a second sub-topic represented in the second knowledge graph, determining whether the first sub-topic and the second sub-topic are identical, and, if the first sub-topic and the second sub-topic are determined to be identical, merging a representation of the first sub-topic in the first knowledge graph with a representation of the second sub-topic in the second knowledge graph;

In some embodiments of the method, if the first sub-topic and the second sub-topic are determined to be distinct, the method comprises determining third connection information indicating relationships between the second sub-topic and the one or more sub-topics represented in the first knowledge graph, and appending the second sub-topic to the first knowledge graph based on the third connection information.

In some embodiments of the method, the steps for generating the first knowledge graph are executed automatically upon receipt of a threshold number of documents from the one or more information sources.

In some embodiments, the method comprises receiving a request for the first knowledge graph for the topic from the user.

In some embodiments of the method, the plurality of textual entities extracted from the one or more documents belong to the same part of speech class.

In some embodiments of the method, the one or more artificial intelligence models comprise one or more natural language processing algorithms.

In some embodiments of the method, in the first knowledge graph, the one or more sub-topics are represented as one or more nodes and the relationships between the one or more sub-topics are represented as one or more edges connecting said nodes.

In some embodiments of the method, providing a graphical representation of the first knowledge graph to the user using a graphical user interface.

In some embodiments, the method comprises receiving, via the graphical user interface, user input comprising a selection of a sub-topic of the one or more sub-topics represented in the first knowledge graph, and in response to receiving the user input comprising the selection, displaying, on the graphical user interface, information about the selected sub-topic, wherein the information comprises an indication of documents of the one or more documents that contain text related to the selected sub-topic.

A system for generating a knowledge graph for a topic may comprise one or more memories and one or more processors configured to: receive one or more documents from one or more information sources; receive an indication of one or more exemplary entities associated with the topic from a user; automatically, using one or more artificial intelligence models: extract a plurality of textual entities from the one or more documents, determine a quality level of each of the plurality of textual entities based on the one or more exemplary entities received from the user, wherein a quality level of a textual entity indicates a degree of similarity between the textual entity and each exemplary entity of the one or more exemplary entities, identify a plurality of high-quality textual entities from the plurality of textual entities based on the respective quality levels of the plurality of textual entities, categorize each of the plurality of high-quality entities according to one or more sub-topics associated with the topic, and determine connection information indicating relationships between the one or more sub-topics based on documents of the one or more documents from which each of the plurality of high-quality entities originated; and generate, based on the one or more sub-topics and the connection information, a first knowledge graph for the topic that represents the one or more sub-topics in the one or more documents and the relationships between said sub-topics.

A non-transitory computer readable storage medium may store instructions that, when executed by one or more processors of an electronic device, cause the device to: receive one or more documents from one or more information sources; receive an indication of one or more exemplary entities associated with the topic from a user; automatically, using one or more artificial intelligence models: extract a plurality of textual entities from the one or more documents, determine a quality level of each of the plurality of textual entities based on the one or more exemplary entities received from the user, wherein a quality level of a textual entity indicates a degree of similarity between the textual entity and each exemplary entity of the one or more exemplary entities, identify a plurality of high-quality textual entities from the plurality of textual entities based on the respective quality levels of the plurality of textual entities, categorize each of the plurality of high-quality entities according to one or more sub-topics associated with the topic, and determine connection information indicating relationships between the one or more sub-topics based on documents of the one or more documents from which each of the plurality of high-quality entities originated; and generate, based on the one or more sub-topics and the connection information, a first knowledge graph for the topic that represents the one or more sub-topics in the one or more documents and the relationships between said sub-topics.

### BRIEF DESCRIPTION OF THE FIGURES

The following figures show various systems and methods for generating topic-specific knowledge graphs. The systems and methods shown in the figures may have any one or more of the characteristics described herein.

FIGS. 1A-1C shows inputs to and outputs from a system for generating topic-specific knowledge graphs, according to some embodiments.

FIG. 2 shows a system for generating a topic-specific knowledge graph, according to some embodiments.

FIG. 3 illustrates a method for generating a topic-specific knowledge graph, according to some embodiments.

FIG. 4 shows an entity-document matrix, according to some embodiments.

FIG. 5 shows a computer system, according to some embodiments.

### DETAILED DESCRIPTION

As described, knowledge graphs can organize and provide structure to important information contained in a set of documents. However, knowledge graphs are frequently unfocused. A knowledge graph for a large document or a large set of documents may represent information related to a wide range of topics. As a result, users who are interested in a specific topic may need to closely search the knowledge graph in order identify relevant portions of the graph, a process which may be both tedious and time consuming. Knowledge graphs may also be difficult to update once generated. Whenever documents are added or removed from an underlying document set, a new knowledge graph may need to be generated from scratch. This may be extremely inefficient, particularly for document sets containing large amounts of data.

Accordingly, provided are systems and methods for generating topic-specific knowledge graphs. A topic-specific knowledge graph for a set of documents may provide a representation of information in the set of documents that is related to a certain topic. The described systems and methods may generate topic-specific knowledge graphs by leveraging artificial intelligence models (including natural language processing algorithms) guided by user inputs and feedback. Specifically, words, phrases, and concepts (referred to herein as “textual entities”) may be extracted from a set of documents and subsequently filtered based on exemplary topic-relevant words, phrases, and concepts provided by the user. The filtering procedure may remove irrelevant textual entities so that only those entities that are associated with the user's topic of interest are represented in the knowledge graph. To reduce errors, the user may provide periodic or continuous feedback to the system during execution of the filtering procedure. The resulting knowledge graph may help the user to identify documents in the document set that are most relevant to their topic of interest.

In addition to providing topic-specific knowledge graphs, the described techniques may also be used to efficiently update existing knowledge graphs. When new documents are added to an existing set of documents, a knowledge graph may be generated for the new documents. The newly-generated knowledge graph may then be compared to an existing knowledge graph representing the existing set of documents prior to the addition of the new documents. Portions of the newly generated knowledge graph may be merged with sufficiently similar portions of the existing knowledge graph. If there exists a portion of the newly generated knowledge graph for which no similar portion exists in the existing knowledge graph, then that portion of the newly generated knowledge graph may be appended to the existing graph.

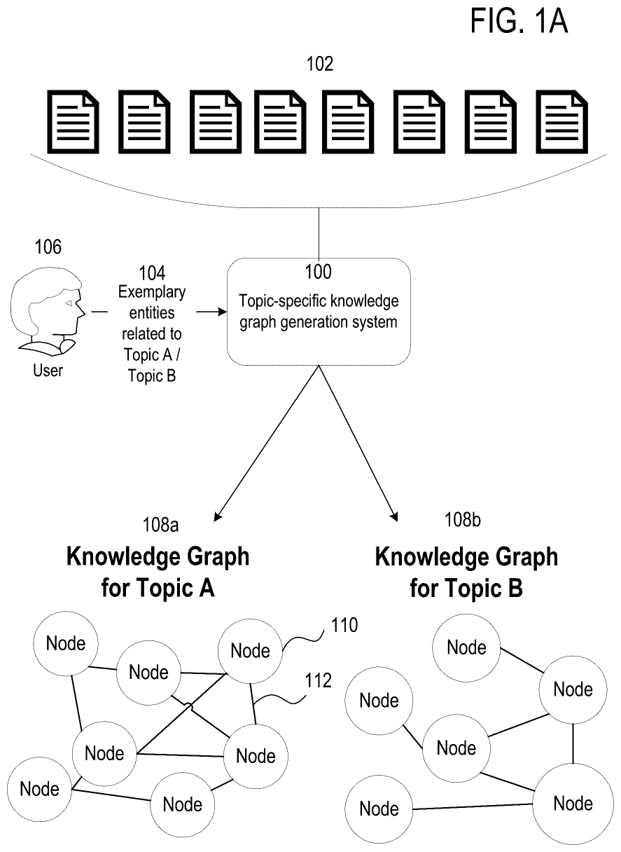

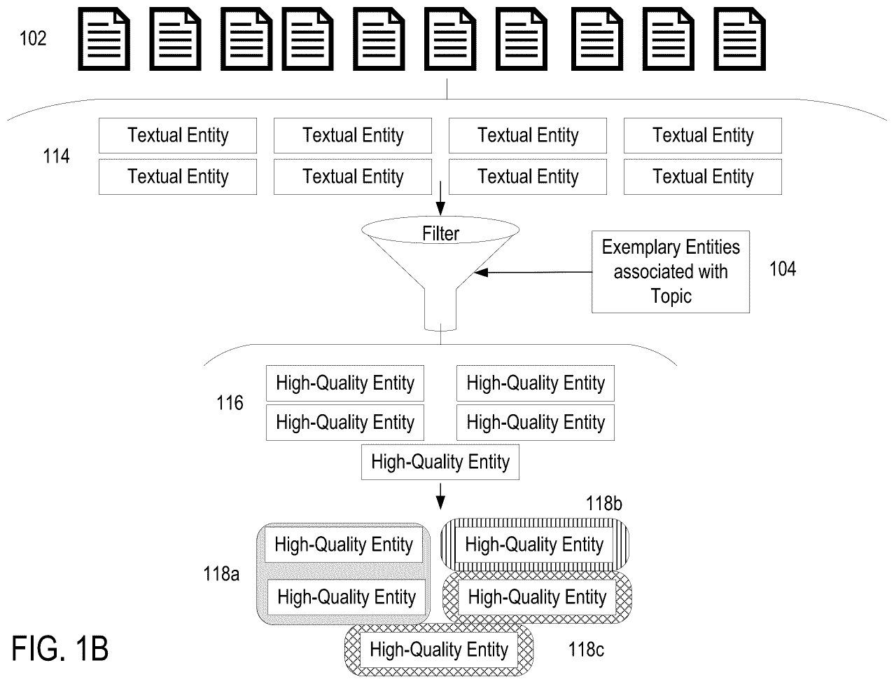

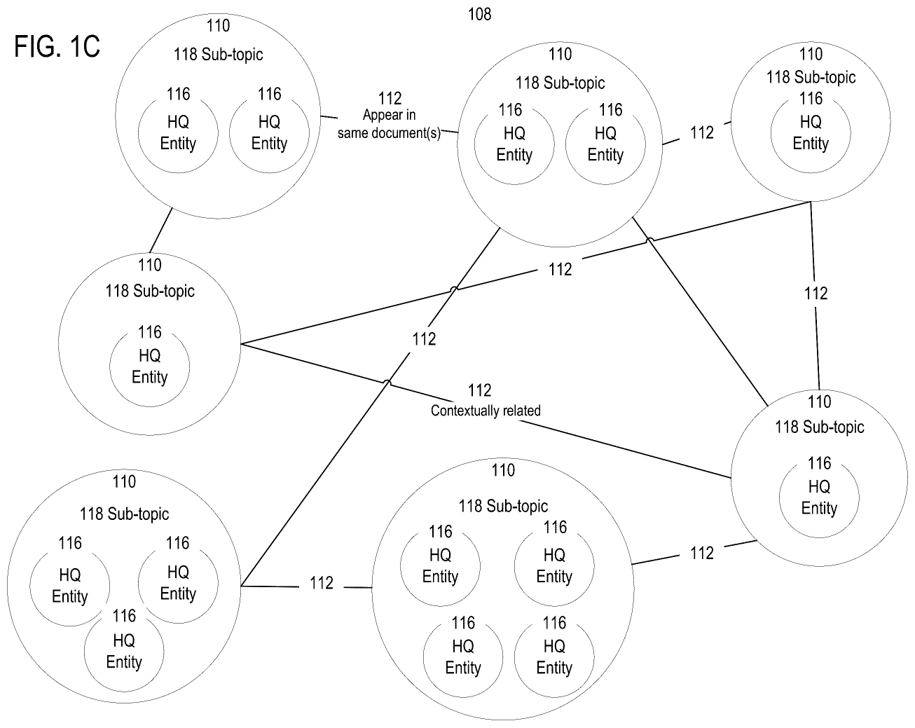

FIG. 1A illustrates exemplary inputs and outputs from a system 100 for generating topic-specific knowledge graphs for a set of documents 102. As shown, inputs to system 100 may include documents 102 as well as one or more indications of a set of exemplary entities 104. Exemplary entities 104 may be words, phrases, or concepts provided by a user 106 that indicate one or more topics of interest to user 106. Guided by exemplary entities 104, system 100 may generate one or more knowledge graphs that organize and represent information contained in documents 102 that is relevant to the topics of interest to user 106. For example, if topical information 104 indicates that user 106 is interested in two distinct topics (labeled Topic A and Topic B in FIG. 1), then system 100 may output a first knowledge graph 108a that represents information relevant to the first topic that is present in documents 102 and a second knowledge graph 108b that represents information relevant to the second topic that is present in documents 102.

Documents 102 may comprise any written or otherwise text-based materials, including (but not limited to) articles (e.g., scientific articles, news articles, magazine articles, etc.), books, transcriptions, reports, legal documents (e.g., contracts, agreements, etc.), employment documents (e.g., resumés, CVs, etc.), mail, emails, and financial documents (e.g., receipts, tax statements, accounting documents, etc.). Documents 102 may be provided to system 100 as word processor files (e.g., Microsoft Word files (.doc files or .docx files)), plain text files (e.g., .txt files), rich text files (e.g., .rtf files), PDF files, markup files (e.g., LaTex files (.tex files)), or a combination thereof. Documents 102 can include handwritten documents as well as typed documents. In some embodiments, documents 102 can include documents written in one or more different languages. Documents 102 can be uploaded to system 100 by a user (e.g., user 106) or can be automatically received by system 100 from information sources such as document databases.

Exemplary entities 104 may be words, phrases, or concepts associated with a topic (or topics) of interest to user 106. For instance, if user 106 wishes to determine what information about accounting is included in documents 102, exemplary entities 104 may include words or phrases related to the topic of accounting, such as “tax”, “asset”, or “interest”. Additional examples of possible exemplary entities 104 that may be provided by a user to contextualize various example topics of interest are provided in Table 1.

TABLE 1

| Topic of Interest | Exemplary Entities |
|---|---|
| Accounting | Tax, asset, interest, business, credit |
| Human Resources | Benefits, payroll, recruiting |
| Investments | Stock, bond, fund, market |
| Artificial Intelligence | Machine learning, artificial neural network, |
| | regression |
| Health care | Medicine, doctor, treatment |

In addition to providing exemplary entities 104, user 106 may provide an explicit indication of a topic or topics that exemplary entities 104 are related to. This may help to contextualize exemplary entities 104. If, for example, exemplary entities 104 can be associated with a plurality of different topics, but user 106 is only interested in a single topic of the plurality of different topics, user 106 may indicate their topic of interest to prevent system 100 from extracting unnecessary information from documents 102. Alternatively, if user 106 is interested in multiple different topics, user 106 may explicitly indicate which exemplary entities 104 are associated with which topic of interest.

The topic-specific knowledge graphs output by system 100 may comprise a plurality of nodes 110. Each node 110 may represent a sub-topic that is associated with the topic of the knowledge graph. In turn, each sub-topic may encompass one or more textual entities (e.g., words, phrases, or concepts) associated with the topic of the knowledge graph that are present in documents 102. Nodes 110 representing closely related sub-topics may be connected by edges 112.

FIG. 1B illustrates a process by which system 100 may generate a topic-specific knowledge graph such as knowledge graph 108a or knowledge graph 108b. Textual entities 114 may be extracted from documents 102 by system 100 using a one or more artificial intelligence models. Then, using exemplary entities 104, system 100 may filter the extracted entities to remove those entities that are not related to the user's topic of interest, leaving only “high-quality” textual 116 that are closely associated with the topic of interest. These high-quality textual entities may then be categorized into sub-topics (e.g., sub-topics 118a-118c). A sub-topic may encompass a single high-quality entity or multiple high-quality entities. System 100 may identify sub-topics that should be connected by determining, e.g., whether a pair of sub-topics encompass closely associated textual entities, or whether a pair of sub-topics encompass textual entities that originated from the same document of documents 102.

FIG. 1C illustrates an exemplary topic-specific knowledge graph 108 that may be generated by system 100. As described, each node 110 may represent a sub-topic 118. Each sub-topic 118 may encompass one or more high-quality entities 116. Edges 112 may indicate relationships between nodes.

In some embodiments, two nodes can be connected by an edge if, for example, the sub-topics represented by said nodes encompass high-quality entities that appear in the same documents or if the sub-topics represented by said nodes are determined to be contextually related. In some embodiments, two nodes can be connected by an edge if the sub-topics represented by said nodes encompass high-quality entities that share certain entity characteristics (e.g., part of speech). In some embodiments, a first node may be connected to a second node by an edge if the sub-topic represented by the first node is itself a sub-topic of the sub-topic represented by the second node.

Knowledge graph 108 may be provided to a user in a variety of formats. In some embodiments, knowledge graph 108 is provided as a data structure, e.g., as a collection of data values representing nodes 110 and a collection of data values representing edges 112. In some embodiments, in addition to or as an alternative to providing knowledge graph 108 as a data structure, system 100 may be configured to display a visualization or graphical representation of knowledge graph 108, for example with nodes 110 represented by shapes (e.g., circles, squares, etc.) and edges 112 represented by lines.

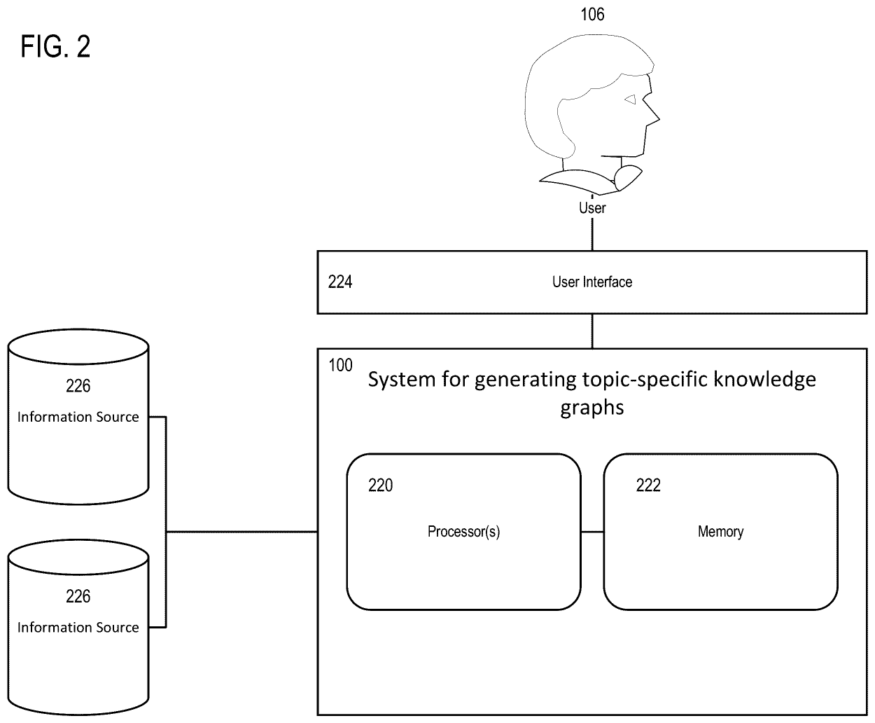

A block diagram of system 100 is provided in FIG. 2. As shown, system 100 may be a computer system comprising one or more processors 220 and at least one memory 222. For example, system 100 may be or may comprise a laptop computer, a desktop computer, a mobile device (e.g., a smart phone), a tablet computer, or a server. Processor(s) 220 may include one or more processing units (e.g., digital circuitry, microcontrollers, microprocessors, embedded processors, central processing units (CPUs), graphics processing units (GPUs), etc.). Memory 222 may comprise any device configured to provide storage, including electrical, magnetic, or optical memory. For instance, memory 222 may include random-access memory (RAM), a cache, a hard drive, a CD-ROM drive, a tape drive, or a removable storage disk. Software comprising programs or instructions for generating topic-specific knowledge graphs may be stored in memory 222 for execution by processors 220.

System 100, as described, can receive inputs from a user 106. To facilitate the provision of information to and from user 106, system 100 may be communicatively coupled to a user interface 224. User interface 218 can include a display (e.g., a computer monitor or a screen) configured to be controlled by processors 220. Additionally, user interface 224 may include one or more user input controls such as a keyboard, a mouse, or a touch sensor. User 106 may input exemplary entities (e.g., exemplary entities 104 shown in FIG. 1) or upload documents (e.g., documents 102 shown in FIG. 1) to system 100 via user interface 224. After a knowledge graph is generated, system 100 may display the knowledge graph to user 106 using user interface 224. In some embodiments, user interface 224 may allow user 106 to interact with system 100 while a knowledge graph is being generated, for example to manually edit a set of high-quality entities identified by system 100 or to manually categories entities into sub-topics.

In addition to user interface 224, system 100 may be coupled to one or more information sources 226. Documents (e.g., documents 102 shown in FIG. 1) may be provided to system 100 from information sources 226. Information sources 226 can include servers or databases that store documents (e.g., a database for a company, an email server, or a library database) as well as storage devices such as USB drives, hard drives, or storage disks. System 100 may automatically receive documents from information sources 226 in real time (e.g., as the documents are uploaded to information source 226) or periodically (e.g., at predetermined times of day). Additionally, system 100 may be configured to request specific documents from an information source 226, for example based on instructions received from user 106.

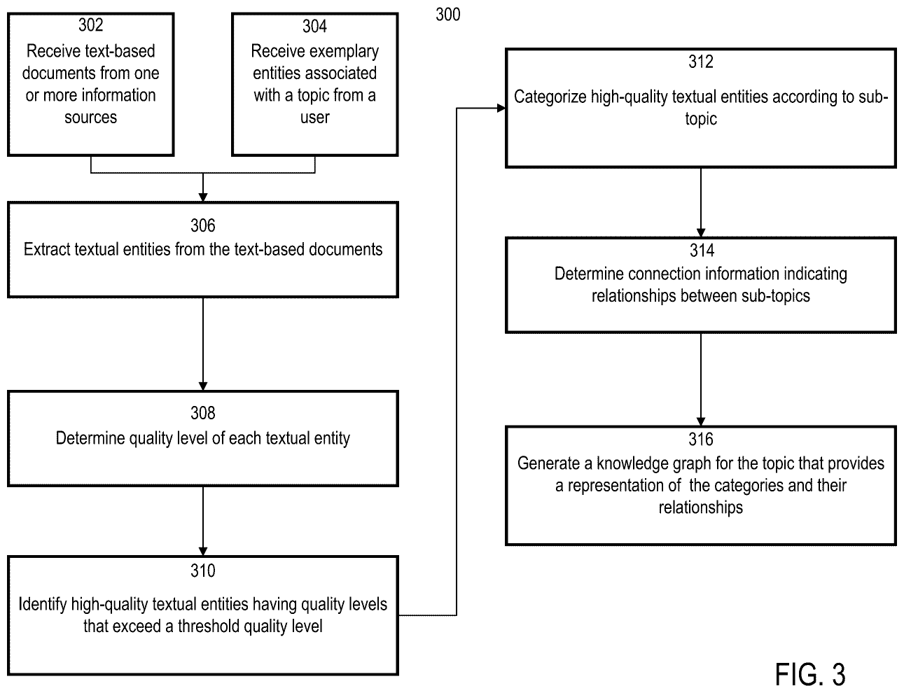

An exemplary method 300 for generating a topic-specific knowledge graph is provided in FIG. 3. Method 300 may be executed by a system for generating a topic-specific knowledge graph such as system 100 shown in FIG. 1A and FIG. 2. In some embodiments, instructions configured to cause one or more processors of a computer system (e.g., system 100) may be stored by a computer-readable medium (e.g., memory 222 of system 100 shown in FIG. 2).

Method 300 may begin with the receipt of text-based documents (e.g., documents 102 shown in FIGS. 1A-1B) by processors of the system executing method 300 from one or more information sources (step 302). The information sources can include sources such as information sources 226 shown in FIG. 2 and/or users of the system executing method 300. The documents can be received automatically can be manually uploaded to the system.

Concurrently (or after) the documents are received, an indication of exemplary textual entities associated with a topic of interest may be received from a user (step 304). The user may provide the exemplary entities to the processors of the system using a user interface that is communicatively coupled to the processors (e.g., user interface 224 shown in FIG. 2). The exemplary entities may include words, phrases, or descriptions of concepts that are associated with, related to, or examples of the topic of interest.

Optionally, at step 304, the user may explicitly indicate the topic of interest with which the exemplary entities are associated. Additionally, the user can indicate a level of importance of each exemplary entity, for example by ranking each exemplary entity with a numerical score that quantifies the relevance or closeness of said exemplary entity to the topic of interest. In some embodiments, the importance levels of the exemplary entities may be used by the system during the extraction of textual entities from the documents (sec, e.g., step 306 of method 300).

In some embodiments, the number of exemplary entities that a user can provide may be restricted. For example, the user may be permitted to submit no more than 1, no more than 2, no more than 3, no more than 4, no more than 5, no more than 10, no more than 20, no more than 50, or no more than 100 exemplary entities. Limiting the number of exemplary entities provided by the user may prevent excessive confinement of artificial intelligence models employed in later steps of method 300. In other embodiments, the user may be required to submit at least a minimum number of exemplary entities to ensure that the artificial intelligence models are provided with sufficient guidance. For example, the user may be required to submit at least 1, at least 2, at least 3, at least 4, at least 5, at least 10, at least 20, at least 50, or at least 100 exemplary entities. In some cases, the user may be provided with a preferred range of exemplary entities that they should submit, based on, for example, the total number of documents received in step 302, the total number of words contained in the documents received in step 302, or the file sizes of the documents received in step 302.

The type of exemplary entities that a user can provide may also be defined or restricted. For instance, the user may only be permitted to submit exemplary entities of a specific part of speech class (e.g., nouns, verbs, etc.). Limiting the type of exemplary entities provided by the user may increase the efficiency of knowledge graph generation.

Following steps 302 and 304, raw textual entities may be extracted from the documents (step 306). The raw textual entities may be extracted using a natural language processing (NLP) algorithm. The NLP algorithm may scan each document and categorize each textual entity (e.g., each word) in each document according to one or more characteristics of the entity, for example according to the entity's part of speech class. In some embodiments, entities which lack certain characteristics may be discarded.

In some embodiments, the NLP algorithm includes a name entity recognition (NER) component and a key phrase extraction component. This NLP algorithm may extract textual entities of a certain part of speech class that contain specific information, then filter out any generic words that do not provide relevant information. For example, the NLP algorithm may extract nouns or noun phrases that contain specific information, then filter out pronouns or pronoun phrases (e.g., “it”, “they”, etc.).

After the raw textual entities are extracted from the documents, a quality level of each textual entity may be determined (step 308). This step may be the first in a filtering process intended to refine the set of extracted textual entities so that only “high-quality” entities related to the topic of interest are retained. The quality level of a textual entity may indicate (e.g., through a numerical score or ranking) a degree of similarity between the textual entity and one or more of the exemplary entities provided by the user in step 304. One or more artificial intelligence models may be leveraged in the determination of the quality levels.

In some embodiments, the quality levels can be determined using semantic embedding. The meanings of each raw textual entity and each exemplary entity may be encoded in an N-dimensional vector (where N>0 is a positive integer). The similarity between a vector \vec{V_{raw}} representing a raw textual entity and a vector \vec{Vₑₓ} representing an exemplary textual entity may be quantified by computing the cosine similarity score between \vec{V_{raw}} and \vec{Vₑₓ}. The cosine similarity score may be the cosine of the angle θ between \vec{V_{raw}} and \vec{Vₑₓ}, which may be computed, for example, using Equation 1:

$$cos θ = \frac{\vec{{V}_{raw}} \cdot {\vec{{V}_{ex}}}^{}}{\vert {\vec{{V}_{raw}}}^{} \vert \vert {\vec{{V}_{ex}}}^{} \vert} \qquad ( Eq . 1 )$$

In Equation 1, \vec{V_{raw}}·\vec{Vₑₓ} is the inner product of \vec{V_{raw}} and \vec{Vₑₓ}, and |\vec{V_{raw}}|\vec{Vₑₓ}| is the product of the magnitude of \vec{V_{raw}} and the magnitude of \vec{Vₑₓ}. The quality level of a textual entity represented by a vector \vec{V_{raw}} may be determined based on the cosine similarity scores between \vec{V_{raw}} and the vectors representing each exemplary entity provided by the user in step 304.

Next, a set of high-quality textual entities may be identified from within the set of raw textual entities based on the determined quality levels (step 310). The high-quality textual entities may be identified using one or more artificial intelligence models. In some embodiments, high-quality textual entities include all raw textual entities that have a quality level which exceeds a threshold quality level. The threshold quality level may be provided by a user and may depend on how focused the user wishes the generated knowledge graph to be on the topic of interest. A user who desires a highly focused knowledge graph may set a high threshold quality level so that only those entities that are most closely related to the topic of interest are identified as high-quality entities. Alternatively, a user who desires a broader knowledge graph may set a low threshold quality level in order to capture a wider range of entities. The identification of high-quality textual entities may conclude the filtering process.

Optionally, the user may provide input during the filtering process (steps 308-310). When a set of high-quality textual entities is identified, the set may be provided to the user, who may then determine whether each entity in the set should be retained or discarded. Based on the user's assessment, high-quality entities may be re-identified (e.g., by repeating steps 308-310). Looping in the user in this manner may allow errors made by the system (e.g., misinterpretation of entity meaning) to be flagged and eliminated. In some embodiments, the system can by trained by input provided by the user to improve the filtering process.

Once the high-quality textual entities have been identified, they may be categorized according to sub-topic (step 312). Sub-topics may be a division or sub-group of the topic of interest. Each sub-topic may encompass one or more of the high-quality textual entities.

The process of categorizing the high-quality textual entities according to sub-topic may be fully automated or may require user input. In some embodiments, artificial intelligence models are employed to cluster the high-quality textual entities based on, e.g., the definitions of the high-quality textual entities or the parts of speech of the high-quality textual entities. In some embodiments, the high-quality textual entities are categorized into sub-topics based on their cosine similarity scores. The cosine similarity score between each high-quality textual entity and every other high-quality textual entity may be computed. High-quality entities with cosine similarity scores above a predetermined threshold may be clustered into a sub-topic. Optionally, the user may provide input during the clustering process to ensure that the identified sub-topics are coherent and sufficiently narrow (e.g., to ensure that the clustering is fine-grained enough to usably organize the information in the documents).

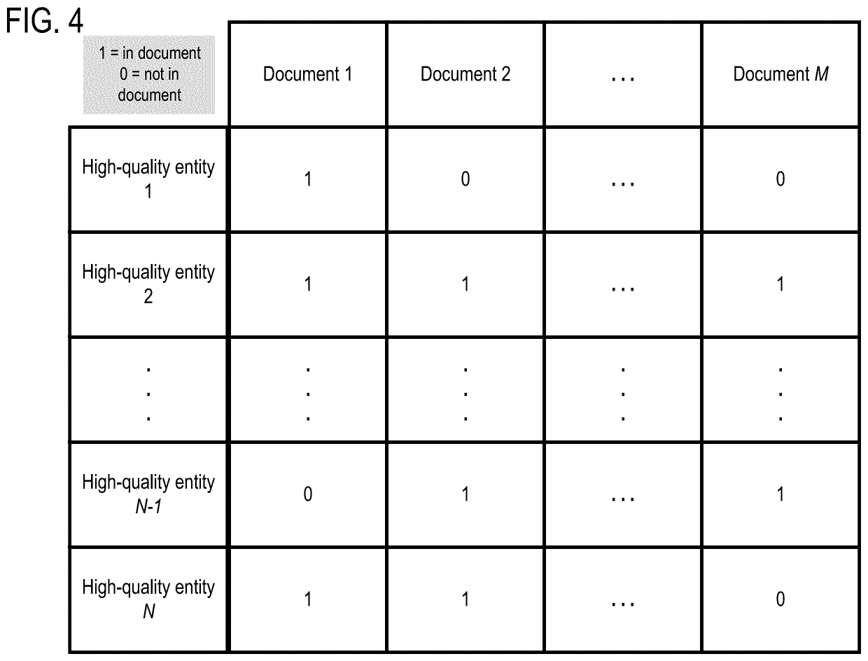

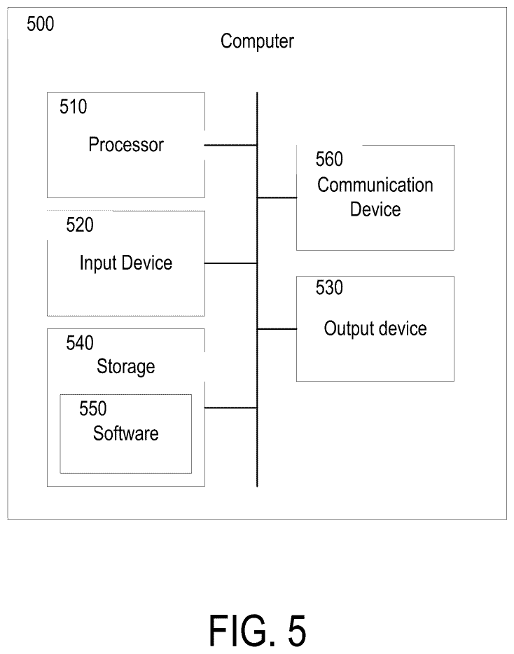

Connection information indicating relationships between sub-topics may then be determined (step 314). The connection information may be determined by generating an entity-document matrix that indicates the documents in the set of documents received in step 302 in which each high-quality textual entity can be found, as shown in FIG. 4. A pair of sub-topics may be determined to be connected if a threshold number of high-quality textual entities encompassed by each sub-topic are present in at least a threshold number of documents. The threshold number of documents can be determined by the user or can be determined automatically. In some embodiments, the threshold number of documents can depend upon the total number of documents received in step 302.

After the high-quality textual entities have been categorized according to sub-topic and connection information for the sub-topics has been determined, a knowledge graph may be generated (step 316). The generated knowledge graph may represent the information contained in the documents that pertains to the topic of interest. As shown in FIG. 1C, the nodes of the knowledge graph may represent sub-topics, each of which, in turn, may encompass one or more high-quality entities. The edges of the knowledge graph may indicate relationships between sub-topics.

The generated knowledge graph may be provided to the user via a user interface (e.g., user interface 224 shown in FIG. 2). Specifically, the knowledge graph may be displayed to the user as a graphical user interface (GUI) configured to allow the user to interact with the knowledge graph in order to receive additional details about the information represented by the graph. If, for example, the user wishes to be provided with additional details about a specific sub-topic, the user may select the node in the knowledge graph that corresponds to the sub-topic of interest. Upon receipt of the node selection, the user interface may be configured to display data about the sub-topic, including, for instance, a list of the high-quality textual entities encompassed by the sub-topic or a list of documents from the set of documents received in step 302 that contain the high-quality entities encompassed by the sub-topic. This may allow users to quickly identify specific information contained in each document so that they may read only those documents that are relevant to their topic (or sub-topic) of interest.

In some embodiments, method 300 may be automatically executed when a threshold number of documents become available. The threshold number of documents can be at least 1, at least 5, at least 10, at least 20, at least 50, at least 100, at least 200, at least 500, or at least 500 documents. In other embodiments, method 300 may be executed upon receipt of a request for a knowledge graph from a user.

Topic-specific knowledge graphs generated using method 300 may be used to update existing knowledge graphs. Each node in a newly generated knowledge graph may be compared to nodes in an existing knowledge graph to determine whether any nodes in the newly generated knowledge graph are (approximately) identical to nodes in the existing knowledge graph. A node in the newly generated knowledge graph may be compared to existing nodes by determining degrees of similarity between textual entities encompassed by the new node and textual entities encompassed by the existing nodes (similar to, e.g., step 308 of method 300) and/or determining connection information indicating relationships between the new node and the existing nodes (similar to, e.g., step 314 of method 300). If the new node is determined to be distinct from all of the nodes in the existing knowledge graph, the new node may be appended to the existing knowledge graph by adding new edges between existing nodes and the new node (based on, e.g., connection information determined using a process similar to step 314 of method 300). If, however, the new node is determined to be sufficiently similar or identical to a node in the existing knowledge graph, the new node may be merged with the similar/identical node in the existing graph. In this manner, existing knowledge graphs may be efficiently updated, for example as new documents that are potentially related to a topic are received.

In one or more examples, the disclosed systems and methods utilize or may include computer system. FIG. 10 illustrates an exemplary computing system according to one or more examples of the disclosure. Computer 500 can be a host computer connected to a network. Computer 500 can be a client computer or a server. As shown in FIG. 10, computer 500 can be any suitable type of microprocessor-based device, such as a personal computer, workstation, server, or handheld computing device, such as a phone or tablet. The computer can include, for example, one or more of processor 510, input device 520, output device 530, storage 540, and communication device 560. Input device 520 and output device 530 can correspond to those described above and can either be connectable or integrated with the computer.

Input device 520 can be any suitable device that provides input, such as a touch screen or monitor, keyboard, mouse, or voice-recognition device. Output device 530 can be any suitable device that provides an output, such as a touch screen, monitor, printer, disk drive, or speaker.

Storage 540 can be any suitable device that provides storage, such as an electrical, magnetic, or optical memory, including a random-access memory (RAM), cache, hard drive, CD-ROM drive, tape drive, or removable storage disk. Communication device 560 can include any suitable device capable of transmitting and receiving signals over a network, such as a network interface chip or card. The components of the computer can be connected in any suitable manner, such as via a physical bus or wirelessly. Storage 540 can be a non-transitory computer-readable storage medium comprising one or more programs, which, when executed by one or more processors, such as processor 510, cause the one or more processors to execute methods described herein.

Software 550, which can be stored in storage 540 and executed by processor 510, can include, for example, the programming that embodies the functionality of the present disclosure (e.g., as embodied in the systems, computers, servers, and/or devices as described above). In one or more examples, software 550 can include a combination of servers such as application servers and database servers.

Software 550 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 540, that can contain or store programming for use by or in connection with an instruction execution system, apparatus, or device.

Software 550 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 500 can implement any operating system suitable for operating on the network. Software 550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

As used herein, the singular forms “a”, “an”, and “the” include the plural reference unless the context clearly dictates otherwise. Reference to “about” a value or parameter herein includes (and describes) variations that are directed to that value or parameter per se. For example, description referring to “about X” includes description of “X”. It is understood that aspects and variations of the invention described herein include “consisting of” and/or “consisting essentially of” aspects and variations.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A method for generating a knowledge graph for a topic, the method comprising:
receiving one or more documents from one or more information sources;
receiving an indication of one or more exemplary entities associated with the topic from a user;
automatically, using one or more artificial intelligence models:
extracting a plurality of textual entities from the one or more documents,
determining a quality level of each of the plurality of extracted textual entities based on the one or more exemplary entities received from the user, wherein a quality level of a textual entity indicates a degree of similarity between the textual entity and each exemplary entity of the one or more exemplary entities,
identifying a plurality of high-quality textual entities from the plurality of textual entities based on the respective quality levels of the plurality of extracted textual entities,
categorizing each the plurality of high-quality entities according to one or more sub-topics associated with the topic, and
determining connection information indicating relationships between the one or more sub-topics based on documents of the one or more documents from which each of the plurality of high-quality entities originated; and
generating, based on the one or more sub-topics and the connection information, a first knowledge graph for the topic that represents the one or more sub-topics in the one or more documents and the relationships between said sub-topics.

2. The method of claim 1, comprising:
providing an indication of the plurality of high-quality textual entities to the user;
receiving feedback from the user indicating an accuracy of one or more of the plurality of high-quality textual entities; and
automatically updating the plurality of high-quality textual entities based on the feedback received from the user.

3. The method of claim 1, wherein determining the quality level of a textual entity of the plurality of textual entities comprises:
generating a first vector representing the textual entity;
generating a second vector representing an exemplary entity of the one or more exemplary entities; and
computing a similarity score between the first vector and the second vector, wherein the similarity score indicates a degree of similarity between the textual entity and the exemplary entity.

4. The method of claim 1, wherein identifying the plurality of high-quality textual entities comprises identifying textual entities of the plurality of textual entities with quality levels that exceed a threshold quality level.

5. The method of claim 1, wherein determining the connection information comprises generating a matrix that indicates which documents of the one or more documents contain which high-quality entities of the plurality of high-quality entities.

6. The method of claim 1, comprising:
receiving a second set of one or more documents from the one or more information sources;
automatically, using the one or more artificial intelligence models:
extracting a second plurality of textual entities from the second set of one or more documents,
determining a quality level of each textual entity of the second plurality of textual entities based on the one or more exemplary entities received from the user, wherein a quality level of a textual entity indicates a degree of similarity between the textual entity and each exemplary entity of the one or more exemplary entities,
identifying a second plurality of high-quality textual entities from the second plurality of textual entities based on the quality levels of each textual entity of the second plurality of textual entities,
categorizing the second plurality of high-quality entities according to a second set of one or more sub-topics associated with the topic, and
determining second connection information indicating relationships between the second set of one or more sub-topics; and
generating, based on the second set of one or more sub-topics and the second connection information, a second knowledge graph for the topic that provides a visual representation of the second set of one or more sub-topics in the second set of one or more documents and the relationships between said sub-topics.

7. The method of claim 6, comprising combining the first knowledge graph with the second knowledge graph.

8. The method of claim 7, wherein combining the first knowledge graph with the second knowledge graph comprises:
comparing a first sub-topic represented in the first knowledge graph with a second sub-topic represented in the second knowledge graph;
determining whether the first sub-topic and the second sub-topic are identical; and
if the first sub-topic and the second sub-topic are determined to be identical:
merging a representation of the first sub-topic in the first knowledge graph with a representation of the second sub-topic in the second knowledge graph.

9. The method of claim 8, wherein, if the first sub-topic and the second sub-topic are determined to be distinct:
determining third connection information indicating relationships between the second sub-topic and the one or more sub-topics represented in the first knowledge graph; and
appending the second sub-topic to the first knowledge graph based on the third connection information.

10. The method of claim 1, wherein the steps for generating the first knowledge graph are executed automatically upon receipt of a threshold number of documents from the one or more information sources.

11. The method of claim 1, comprising receiving a request for the first knowledge graph for the topic from the user.

12. The method of claim 1, wherein the plurality of textual entities extracted from the one or more documents belong to the same part of speech class.

13. The method of claim 1, wherein the one or more artificial intelligence models comprise one or more natural language processing algorithms.

14. The method of claim 1, wherein, in the first knowledge graph, the one or more sub-topics are represented as one or more nodes and the relationships between the one or more sub-topics are represented as one or more edges connecting said nodes.

15. The method of claim 1, comprising providing a graphical representation of the first knowledge graph to the user using a graphical user interface.

16. The method of claim 15, comprising:
receiving, via the graphical user interface, user input comprising a selection of a sub-topic of the one or more sub-topics represented in the first knowledge graph; and
in response to receiving the user input comprising the selection, displaying, on the graphical user interface, information about the selected sub-topic, wherein the information comprises an indication of documents of the one or more documents that contain text related to the selected sub-topic.

17. A system for generating a knowledge graph for a topic, the system comprising one or more memories and one or more processors configured to:
receive one or more documents from one or more information sources;
receive an indication of one or more exemplary entities associated with the topic from a user;
automatically, using one or more artificial intelligence models:
extract a plurality of textual entities from the one or more documents,
determine a quality level of each of the plurality of textual entities based on the one or more exemplary entities received from the user, wherein a quality level of a textual entity indicates a degree of similarity between the textual entity and each exemplary entity of the one or more exemplary entities,
identify a plurality of high-quality textual entities from the plurality of textual entities based on the respective quality levels of the plurality of textual entities,
categorize each of the plurality of high-quality entities according to one or more sub-topics associated with the topic, and
determine connection information indicating relationships between the one or more sub-topics based on documents of the one or more documents from which each of the plurality of high-quality entities originated; and
generate, based on the one or more sub-topics and the connection information, a first knowledge graph for the topic that represents the one or more sub-topics in the one or more documents and the relationships between said sub-topics.

18. A non-transitory computer readable storage medium storing instructions that, when executed by one or more processors of an electronic device, cause the device to:
receive one or more documents from one or more information sources;
receive an indication of one or more exemplary entities associated with the topic from a user;
automatically, using one or more artificial intelligence models:
extract a plurality of textual entities from the one or more documents,
determine a quality level of each of the plurality of textual entities based on the one or more exemplary entities received from the user, wherein a quality level of a textual entity indicates a degree of similarity between the textual entity and each exemplary entity of the one or more exemplary entities,
identify a plurality of high-quality textual entities from the plurality of textual entities based on the respective quality levels of the plurality of textual entities,
categorize each of the plurality of high-quality entities according to one or more sub-topics associated with the topic, and
determine connection information indicating relationships between the one or more sub-topics based on documents of the one or more documents from which each of the plurality of high-quality entities originated; and
generate, based on the one or more sub-topics and the connection information, a first knowledge graph for the topic that represents the one or more sub-topics in the one or more documents and the relationships between said sub-topics.
